(19) United States
(12) Patent Application Publication
(10) Pub. No.: US 2019/0311845 A1
(43) Pub. Date: Oct. 10, 2019

(54) COMMON MODE CHOKE COIL

(71) Applicant: SHT Corporation Limited, Izumisano-shi, Osaka (JP)

(72) Inventors: Tsunetsugu IMANISHI, Izumisano-shi, Osaka (JP); Yasuomi TAKAHASHI, Izumisano-shi, Osaka (JP)

(73) Assignee: SHT Corporation Limited, Izumisano-shi, Osaka (JP)

(21) Appl. No.: 16/308,986

(22) PCT Filed: May 26, 2017
(86) PCT No.: PCT/JP2017/019642

§ 371 Date: Dec. 11, 2018

(30) Foreign Application Priority Data
Jun. 21, 2016 (JP) 2016-122484

(51) Int. Cl. H01F 27/32; H01F 27/24; H01F 27/06

(52) U.S. Cl. CPC H01F 27/325; H01F 27/06; H01F 27/24

(57) ABSTRACT

The present invention provides a bobbin-shaped air-cooled common mode choke coil that can suppress heat generation. The air-cooled common mode choke coil 10 according to the present invention is a common mode choke coil 10 in which an annular core 30 is housed in an annular bobbin 20, and a coil 40 is wound around the outer circumference of the bobbin 20. An airflow path A that allows an airflow B to flow therethrough is formed between the bobbin 20 and the core 30. The bobbin 20 includes one or more openings 21 and 22 that are in communication with the airflow path A. Flanges 23 and 24 are provided protruding along the peripheral edges of each of the openings 21 and 22. The openings 21 and 22 are desirably formed in the outer circumferential surface of the bobbin 20 and reache the upper and lower surfaces of the bobbin 20.

### TECHNICAL FIELD

The present invention relates to a common mode choke coil included in a rectifier circuit in an electric alternating current device such as a power supply circuit or an inverter, an anti-noise circuit, a waveform shaping circuit, a resonance circuit, various types of switching circuits, and the like, and more specifically to an air-cooled common mode choke coil that can suppress an increase in temperature by improving heat dissipation properties.

### BACKGROUND ART

A common mode choke coil included in a circuit in various types of electric alternating current devices is formed by winding a coil around an annular core in an insulated manner. The use of a ferrite core formed by sintering a compacted oxide magnetic material as the core is proposed. The core is housed in a resin bobbin, and a coil is wound around the outer circumference of the bobbin, thus forming a common mode choke coil (for example, Patent Document 1).

### CITATION LIST

Patent Document

[Patent Document 1] JP 2012-59754A

### SUMMARY OF INVENTION

### Technical Problem

A common mode choke coil generates heat when used in a commercial alternating current power supply circuit because Joule heat is generated as a result of the coil being energized. Although the core itself generates little heat, the temperature of the common mode choke coil, in which the core is housed in the bobbin, increases due to conduction, radiation, or convection of the heat generated in the coil. When the temperature of the core increases and exceeds a Curie temperature Tc of the magnetic material, the magnetic properties significantly deteriorate, and the noise suppressing effect is lost. For this reason, it has been necessary to use a material that has a high Curie temperature Tc as the magnetic material of the core, or set the electric current applied to the coil to a low level to suppress heat generation in the coil.

On the other hand, in order to achieve a reduction in the size, weight, and cost of the core while ensuring the effect of suppressing noise over a wide frequency band, an advantageous effect of obtaining an inductance value with fewer windings of the coil can be expected by using a magnetic material that has a high relative magnetic permeability μs. However, in general, a magnetic material with high magnetic permeability has a low Curie temperature Tc, and thus a common mode choke coil that can suppress an increase in the temperature of the core is required.

It is an object of the present invention to provide a bobbin-shaped air-cooled common mode choke coil that can suppress an increase in temperature by improving heat dissipation properties.

### Solution to Problem

An air-cooled common mode choke coil according to the present invention is a common mode choke coil in which an annular core is housed in an annular bobbin, and a coil is wound around an outer circumference of the bobbin. An airflow path that allows an airflow to flow therethrough is formed between the bobbin and the core. The bobbin has at least one opening that is in communication with the airflow path, and a flange is provided in a protruding manner along a peripheral edge of the opening.

The opening may be formed in the outer circumferential surface of the bobbin.

It is desirable that the opening is formed in the outer circumferential surface of the bobbin and reaches upper and lower surfaces of the bobbin.

It is desirable that the flange is flared toward the outer circumference with respect to the opening.

It is desirable that a pair of the openings is provided, and the pair of the openings is formed symmetrically along the diameter of the bobbin.

The core may have a rectangular vertical cross section, and corners of the core may abut against and be supported by an inner surface of the bobbin.

A boss or a rib may be provided protruding on an inner surface of the bobbin, and the core may abut against and be supported by the boss or the rib.

The core may be a ferrite core.

Also, an electric appliance including the common mode choke coil according to the present invention is an electric appliance in which the common mode choke coil described above is mounted on a board housed in a casing. The casing includes an air intake opening and an air exhaust fan, and the common mode choke coil is disposed, with one of the openings pointing toward an upstream side of an airflow formed by the air intake opening and the air exhaust fan.

### Advantageous Effects of Invention

With the air-cooled common mode choke coil according to the present invention, by introducing an airflow into an opening formed in the bobbin, it is possible to release heat in the bobbin from an opening, and suppress an increase in the temperature of the core caused by heat generated in the coil as much as possible. Accordingly, it is possible to use a material with high magnetic permeability that has a low Curie temperature as the magnetic material of the core.

### BRIEF DESCRIPTION OF DRAWINGS

FIG. 1 is a perspective view of an air-cooled common mode choke coil according to an embodiment of the present invention.

FIG. 2 is a cross-sectional view of the air-cooled common mode choke coil, which is cut at substantially mid-height of the core.

FIG. 3 is a cross-sectional view taken along the line III-III shown in FIG. 2.

FIG. 4 is an enlarged cross-sectional view of an airflow path that is formed between the bobbin and the core.

FIG. 5 is an enlarged cross-sectional view showing an embodiment in which bosses are formed on the inner surface of the bobbin.

FIG. 6 is a cross-sectional view of the common mode choke coil, which is cut along the upper surface of the core and shows an airflow that passes through the bobbin.

FIG. 7 is a diagram of an experimental apparatus used in examples.

FIG. 8 is a graph showing a relationship between a DC current applied to a coil according to an example of the present invention and a temperature increase in the coil and a core according to the example of the present invention.

FIG. 9 is a graph showing a relationship between a DC current applied to a coil according to a comparative example and a temperature increase in the coil and a core according to the comparative example.

FIG. 10 is a cross-sectional view showing an example in which the present invention is applied to a three-phase common mode choke coil.

### DESCRIPTION OF EMBODIMENTS

Hereinafter, an air-cooled common mode choke coil 10 according to an embodiment of the present invention will be described with reference to the accompanying drawings. A single-phase common mode choke coil in which a pair of coils 40 and 40 are wound is used as an example of the common mode choke coil 10.

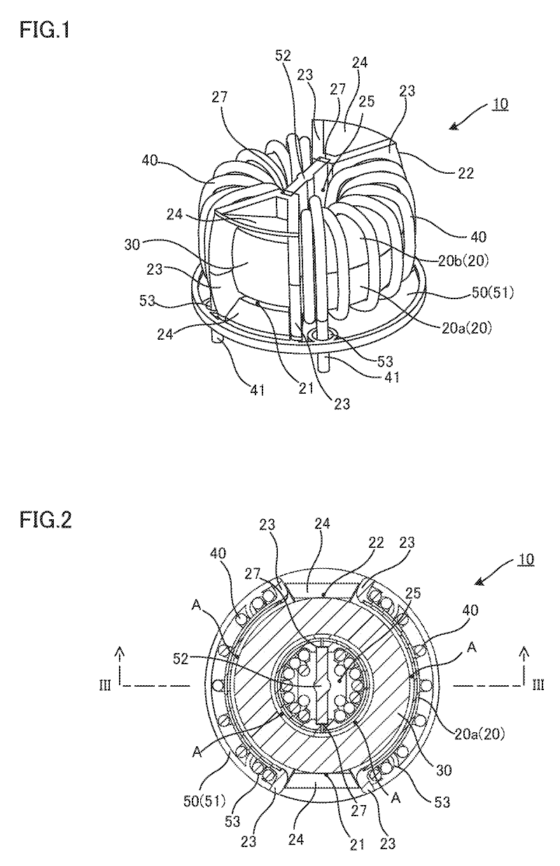

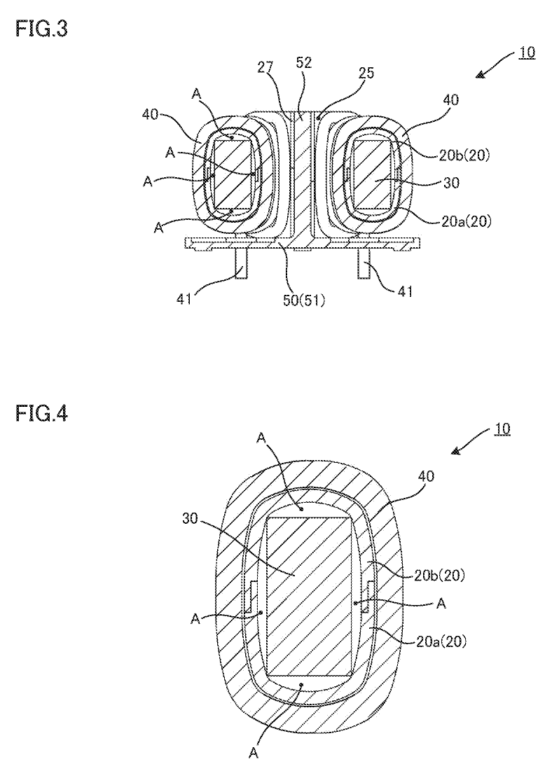

FIG. 1 is an external perspective view of the common mode choke coil 10 according to an embodiment of the present invention. FIG. 2 is a transverse cross-sectional view of the common mode choke coil 10, which is cut at mid-height of a core 30. FIG. 3 is a cross-sectional view taken along the line III-III shown in FIG. 2. FIG. 4 is an enlarged cross-sectional view of the common mode choke coil 10. As shown in the diagrams, the common mode choke coil 10 according to the present invention is formed by housing an annular core 30 in a bobbin 20, and winding a pair of coils 40 and 40 around the circumferential surface of the bobbin 20. Openings 21 and 22 for allowing an external airflow to flow into the bobbin 20 are formed in the bobbin 20.

The core 30 is an annular body made of a magnetic material. The core 30 has a substantially rectangular cross section as shown in the diagrams, but the cross sectional shape is not limited thereto. The core 30 may be, for example, a core (hereinafter also referred to as a “sintered core”) obtained by compact molding a Mn—Zn-based ferrite core material or a Ni—Zn-based ferrite core material and sintering the compacted material.

It is particularly preferable that the present invention is applied to a ferrite core with a high relative magnetic permeability us among sintered cores. Ferrite cores made of a Mn—Zn-based material and a Ni—Zn-based material generally have a relative magnetic permeability us of about 500 to 5000 and a Curie temperature Tc of 180° C. to 250° C. On the other hand, a core 30 mainly made of a Mn—Zn-based material or the like has a high relative magnetic permeability μs as high as 10000 to 18000, and thus an inductance value that is two to three times higher can be obtained even when the number of windings is the same, but the relative magnetic permeability us tends to decrease the closer the Curie temperature Tc of the magnetic material is to 110° C. to 150° C. For this reason, the core 30 needs to be used without increasing the temperature of the core 30 to the Curie temperature Tc or higher.

The bobbin 20 houses the core 30 so as to ensure electric insulation from the coils 40 and 40. The bobbin 20 may be formed of an insulative resin case. In the embodiment shown in the diagrams, the bobbin 20 is configured to be attachable to a coil base 50 that can be attached to a board or the like.

As shown in FIGS. 1 to 4, the bobbin 20 has an annular shape that conforms to the shape of the core 30, and includes a vertically extending through hole portion 25 at the center thereof, and the openings 21 and 22 at one or more positions in the circumferential surface. The bobbin 20 has a larger cross-sectional area on the inner surface side than the cross sectional area of the core 30, and an airflow path A that allows air to flow therethrough is formed between the core 30 and the bobbin 20 in a state where the core 30 is housed in the bobbin 20.

The openings 21 and 22 are formed in the circumferential surface of the bobbin 20. For example, as shown in FIGS. 1 and 2, the openings 21 and 22 can be formed in the outer circumferential surface of the bobbin 20. It is desirable to make the openings 21 and 22 large as they function as an airflow inlet and an airflow outlet. However, if the openings 21 and 22 are large, the number of windings of the coils 40 and 40 that can be wound around the bobbin 20 or the lead wire diameter is limited. Accordingly, the openings 21 and 22 preferably have a maximum opening width sized according to the number of windings of the coils 40 and 40 wound around the bobbin 20 or the lead wire diameter. In the embodiment shown in the diagrams, in order to make the openings 21 and 22 large, the openings 21 and 22 are formed such that a portion thereof extends between the upper and lower surfaces of the bobbin 20.

The openings 21 and 22 are preferably formed at opposing positions across the diameter of the bobbin 20 such that air flows smoothly into and out of the airflow path A. It is most desirable to form two openings in the bobbin 20 as the openings 21 and 22. However, even when only one opening is formed, an airflow can enter the airflow path A in the bobbin 20, and thus an air cooling effect can be expected to a certain degree.

Each of the openings 21 and 22 is provided with flanges 23 and 24 protruding along the peripheral edge thereof. Right and left flanges 23 in each of the openings 21 and 22 secure a creepage distance and a spatial distance specified in safety standards so as to provide electric insulation between the core 30 and the coils 40 and 40 wound around the outer circumference of the bobbin 20, and electric insulation between the coils 40 and 40, as well as preventing these from electrically connecting to each other or from short circuiting and sparking or the like. For this reason, the flanges 23 are designed so as to have a height greater than or equal to the height of the coils 40 and 40 wound near the flanges 23 while having dimensions specified in a safety standard.

In order to increase the airflow that flows through each of the openings 21 and 22, the right and left flanges 23 of each of the openings 21 and 22 have a shape flared toward the outer circumference with respect to the openings 21 and 22. Likewise, in order to increase the amount of air that flows through the openings 21 and 22 and enable smooth guiding of air, the upper and lower flanges 24 of each of the openings 21 and 22 desirably have a vertically flared shape, which is particularly effective when forced-air cooling is performed using a fan or the like.

As described above, the bobbin 20 has, on its inner surface side, a cross-sectional space that is larger than the cross section of the core 30, and a gap provided between the core 30 and the inner surface of the bobbin 20 functions as the airflow path A. The airflow path A is in communication with the openings 21 and 22.

In order to prevent the core 30 from being damaged by mechanical vibrations or impact and suppress magnetostrictive noise caused by a magnetic flux generated by a load current, it is desirable that the bobbin 20 holds the core 30 in the bobbin 20 such that the core 30 does not vibrate in the bobbin 20. For example, as shown in FIGS. 3 and 4, the bobbin 20 is configured to have a substantially elliptical inner surface, and the core 30 partially abuts against the inner surface of the bobbin 20 (in the diagrams, the corners of the core 30 abut against the inner surface of the bobbin 20) so as to secure the airflow path A between the substantially elliptical inner surface and the core 30 while holding the core 30 in the bobbin 20.

Also, when the coils 40 and 40 are wound by hand, the coils 40 and 40 are wound into a substantially elliptical bulging shape. By configuring the bobbin 20 to have a substantially elliptical cross section that conforms to the bulging shape, it is possible to avoid an increase in the size of the common mode choke coil 10 while securing the airflow path A in the bobbin 20.

As shown in FIG. 5, bosses 26 or ribs may be provided protruding on the inner surface of the bobbin 20. It is thereby possible to hold the core 30 by using the bosses 26 or the like while securing the airflow path A between the inner surface of the bobbin 20 and the core 30. In this case, however, as a result of the bosses 26 or the like being provided on the inner surface of the bobbin 20, the airflow path A becomes more narrow, and a turbulent flow may occur in the airflow path A. For this reason, in the case where bosses 26 or ribs are formed, it is desirable to design the bosses 26 or ribs such that a loss in the pressure in the airflow path A can be mitigated as much as possible. In FIG. 5, the core 30 is vertically held by upper and lower bosses 26 and 26, and is horizontally held by abutting the inner circumferential surface of the core 30 against the inner surface of the bobbin 20.

As shown in FIGS. 1 and 3, and the enlarged diagram in FIG. 4, the bobbin 20 configured as described above may be composed of upper and lower bobbin halves 20a and 20b formed by dividing the bobbin 20 into an upper portion and a lower portion. With this configuration, by housing the core 30 in the bobbin half 20a, which is one of the bobbin halves and then fitting the bobbin half 20b, which is the other bobbin half, to the bobbin half 20a, the core 30 can be housed in the bobbin 20.

As shown in FIGS. 1 and 2, the bobbin 20 can be used attached to a coil base 50. In this case, the bobbin 20 includes engaging portions 27 and 27 for engagement with the coil base 50. In the embodiment shown in the diagrams, the engaging portions 27 and 27 are grooves vertically extending through the inner surface of the through hole portion 25.

In the bobbin 20 in which the core 30 is housed, each of the coils 40 and 40 is wound around a body portion of the bobbin 20 between the openings 21 and 22. A common mode choke coil 10 is thereby formed. Copper wires with an insulated outer cover can be used as leads used as the coils 40 and 40. Of course, the leads are not limited thereto.

The two coils 40 and 40 can be wound using so-called common mode winding in which each coil 40 is wound between the openings 21 and 22 in a direction that is the same as the direction of the flow of the load current, or in other words, a direction in which magnetic fluxes generated by the coils 40 and 40 cancel each other out.

The common mode choke coil 10 configured as described above may be disposed directly on a board, or may be attached to a coil base 50 as shown in FIGS. 1 and 3. The coil base 50 may include a base 51 on which the common mode choke coil 10 is placed, and an attachment portion 52 that is provided so as to protrude upward from the base 51. The attachment portion 52 engages with the engaging portions 27 and 27 of the bobbin 20, and thereby fixes the common mode choke coil 10 to the coil base 50. For example, a flat plate-shaped attachment portion 52 as shown in FIGS. 1 and 2 may be used as the attachment portion 52. The attachment portion 52 is fitted into the groove-shaped engaging portions 27 and 27 formed in the through hole portion 25 of the bobbin 20, and the common mode choke coil 10 can thereby be attached to the coil base 50. As a result of the attachment portion 52 being fitted into the through hole portion 25 of the bobbin 20, the common mode choke coil 10 is attached to the coil base 50, and the attachment portion 52 also functions as an insulation wall between the opposing coils 40 and 40.

In the coil base 50, insertion holes 53 and 53 for drawing lead end portions 41 and 41 of the coils 40 and 40 downward may be formed. Accordingly, when the coil base 50 is disposed on a circuit board (not shown), the lead end portions 41 and 41 can be electrically connected to a circuit board.

The following description will be given assuming that the common mode choke coil 10 includes the coil base 50 where appropriate.

The common mode choke coil 10 configured as described above can be mounted on a circuit board in an electric appliance. The casing of the electric appliance includes an air intake opening and an air exhaust fan, or an air intake fan and an air exhaust opening for suppressing an increase in the temperature of electronic components including the common mode choke coil 10, and forcibly generates an airflow in the electronic appliance. Examples of the electric appliance include an IH cooking heater, an IH rice cooker, a microwave oven, a vehicle-mounted DC-DC converter, a vehicle-mounted AC-DC converter, and the like.

The common mode choke coil 10 of the present invention is disposed such that the openings 21 and 22 point in directions on the path of the airflow. If two openings 21 and 22 are formed in the common mode choke coil 10, the common mode choke coil 10 is disposed such that the opening 21, which is one of the openings, points toward the upstream side of the airflow, and the opening 22, which is the other opening, points toward the downstream side. In the case where only one opening is formed, the common mode choke coil 10 is disposed such that the opening points toward the upstream side of the airflow.

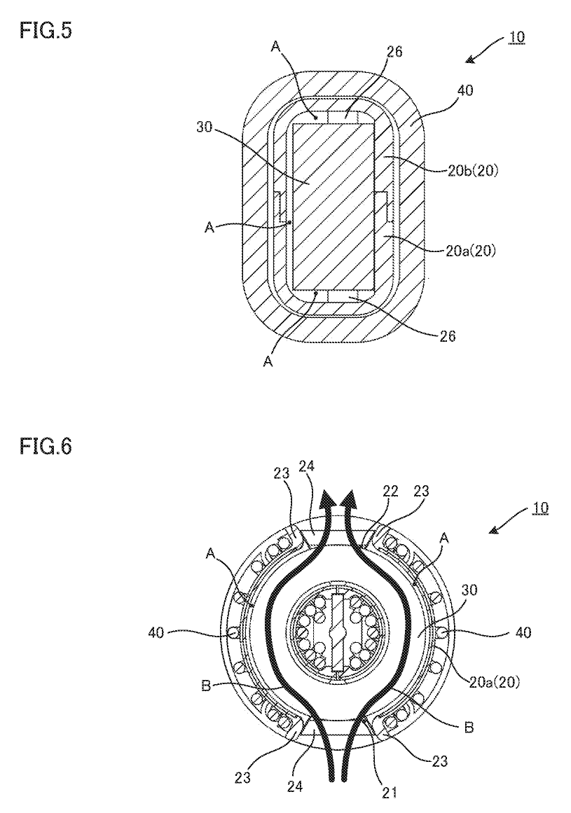

With this configuration, as shown in FIG. 6, in the common mode choke coil 10, an airflow B that enters from the opening 21, passes through the airflow path A formed between the inner surface of the bobbin 20 and the core 30, and is then discharged from the other opening 22 is generated, and the airflow B saps heat from the bobbin 20 and the core 30. Accordingly, it is possible to suppress an increase in the temperature of the coil 40 and the core 30.

To be more specific, when an electric current is supplied to the coils 40 and 40 of the common mode choke coil 10, the coils 40 and 40 generate magnetic fluxes due to electromagnetic induction. However, because the coils 40 and 40 are wound in a direction in which the magnetic fluxes cancel each other out, magnetic saturation is suppressed, and the passage of common mode noise is limited by inductance resulting from self-induction. At this time, Joule heat is generated in the coils 40 and 40 through energization and heat is emitted. Then, the heat generated in the coils 40 and 40 is transmitted to the core 30 via the bobbin 20 through conduction, radiation, or convection, and the temperature of the core 30 increases. However, in the common mode choke coil 10 of the present invention, the airflow B flows into the airflow path A from the opening 21 and is discharged from the other opening 22, and thus the heated bobbin 20 and core 30 are cooled through heat exchange with the airflow B.

Accordingly, because an increase in the temperature of the core 30 can be suppressed, it is possible to use a material that has a high relative magnetic permeability us such as a ferrite core that has a low Curie temperature Tc, and apply a large electric current to the coils 40 and 40. Because the core 30 can be formed using a material that has a high relative magnetic permeability μs, it is possible to reduce the number of windings of the coils 40 and 40 and reduce the lead wire diameter while ensuring the same inductance value, and thus achieve a reduction in the size of the common mode choke coil 10. Conversely, if the size of the common mode choke coil 10 is the same, the inductance value can be designed to be higher by increasing the number of windings of the coils 40 and 40, and thus noise reduction can also be achieved.

### EXAMPLES

A common mode choke coil 10 according to the present invention in which two openings 21 and 22 were formed in the bobbin 20 and a common mode choke coil according to a comparative example whose openings 21 and 22 were closed with a 0.5 mm-thick aramid fiber sheet (product name: Nomex®) were placed in a wind tunnel 60 that forcibly generates an airflow C so as to obtain the relationship between a DC current applied to the coils 40 and 40 and a temperature increase in the coils 40 and the core 30.

The common mode choke coil 10 had the following configuration.

Core 30

Magnetic material: ferrite core MA120A available from JFE Ferrite Co., Ltd. (with a relative magnetic permeability μs of 12000)

Inner diameter/outer diameter: 18.5 mm/31.5 mm

Height: 13.4 mm

Cross-sectional area/cross-sectional shape: 87.1 mm²/rectangular shape

Curie temperature Tc: 120° C.

Bobbin 20

Material: polycarbonate resin

Inner diameter/outer diameter: 17.0 mm/33.0 mm

Height: 14.6 mm

Cross-sectional area/cross-sectional shape: 104.0 mm²/elliptical shape

Opening area: 135.1 mm² each (two openings at diametrically opposing positions)

Cross-sectional area of airflow path A: 16.9 mm² (bobbin cross-sectional area−core cross-sectional area)

Coil 40

Lead material: polyester copper wire (PEW)

Lead wire diameter: 1.8 mm

Number of windings: 13T each

Direct current resistance: 5.2 mΩ×2

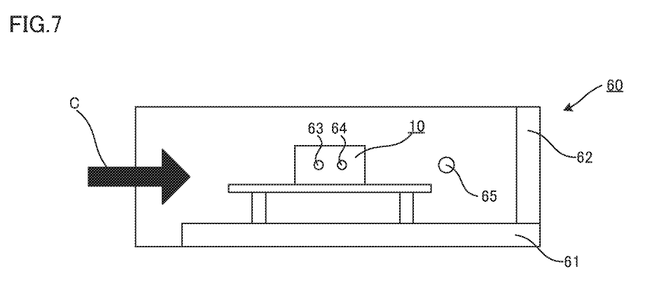

As shown in FIG. 7, a wooden stage 61 with a small heat transfer coefficient was provided in the wind tunnel 60, and the common mode choke coil 10 (see FIG. 1) was placed in the wind tunnel 60 at a position spaced above the wooden stage 61 by 35 mm such that the opening 21 pointed toward the upstream side of the airflow C, and the opening 22 pointed toward the downstream side of the airflow C. Also, an air exhaust fan 62 was provided on the downstream side at a position away from the common mode choke coil 10 by 100 mm. The temperatures of the core 30 and the coil 40 were separately measured using thermocouples 63 and 64, and the wind speed in the wind tunnel 60 was set by adjusting the output of the air exhaust fan 62 based on the measurement value of an airflow meter 65 provided at a position away from the center of the common mode choke coil 10 by 50 mm.

An experiment was performed by placing the wind tunnel 60 in an atmosphere of 25° C., and the wind speed was changed from 0 (a no-wind state, or in other words, a state in which the air exhaust fan was deactivated) to 1.2 m/sec. The DC current applied to the coils was set to 0 A, 10 A, 20 A, and 30 A (note that, in the no-wind state, the DC current applied to the coils was set to 0 A, 10 A, and 20 A in consideration of the heat resistance of the bobbin material).

Actual measurement data of the example of the present invention and the comparative example are shown in Tables 1 and 2, respectively. In Tables 1 and 2, the top row shows the DC current value (A) applied to the coils, and the left column shows the wind speed and measurement point. Other numerical values indicate the temperature increase (° C.) from the atmosphere (25° C.). Although not shown in the tables, when the DC current applied to the coils was 0 A, the temperatures of the core 30 and the coil 40 were 25° C., which was the same as that of the atmosphere, and the temperature increase was 0° C.

TABLE 1

| | 10 A | 20 A | 30 A |
|---|---|---|---|
| Coil in no-wind state | 16.6 | 68.7 | — |
| Core in no-wind state | 13.6 | 59.6 | — |
| Coil at wind speed of 0.5 m/s | 9.0 | 34.7 | 89.8 |
| Core at wind speed of 0.5 m/s | 5.2 | 19.6 | 51.8 |
| Coil at wind speed of 0.75 m/s | 6.7 | 29.9 | 73.5 |
| Core at wind speed of 0.75 m/s | 3.0 | 14.6 | 37.1 |
| Coil at wind speed of 1.0 m/s | 6.2 | 26.5 | 66.0 |
| Core at wind speed of 1.0 m/s | 3.0 | 13.2 | 33.4 |
| Coil at wind speed of 1.2 m/s | 6.2 | 25.4 | 63.1 |
| Core at wind speed of 1.2 m/s | 3.0 | 12.4 | 30.9 |

TABLE 2

| | 10 A | 20 A | 30 A |
|---|---|---|---|
| Coil in no-wind state | 18.8 | 72.8 | — |
| Core in no-wind state | 17.1 | 65.4 | — |
| Coil at wind speed of 0.5 m/s | 7.4 | 40.2 | 108.1 |
| Core at wind speed of 0.5 m/s | 8.4 | 38.6 | 97.1 |
| Coil at wind speed of 0.75 m/s | 6.9 | 33.8 | 87.0 |
| Core at wind speed of 0.75 m/s | 6.7 | 30.4 | 79.5 |
| Coil at wind speed of 1.0 m/s | 6.5 | 30.6 | 76.1 |
| Core at wind speed of 1.0 m/s | 6.2 | 26.7 | 68.9 |
| Coil at wind speed of 1.2 m/s | 6.4 | 26.1 | 67.0 |
| Core at wind speed of 1.2 m/s | 4.8 | 22.1 | 58.3 |

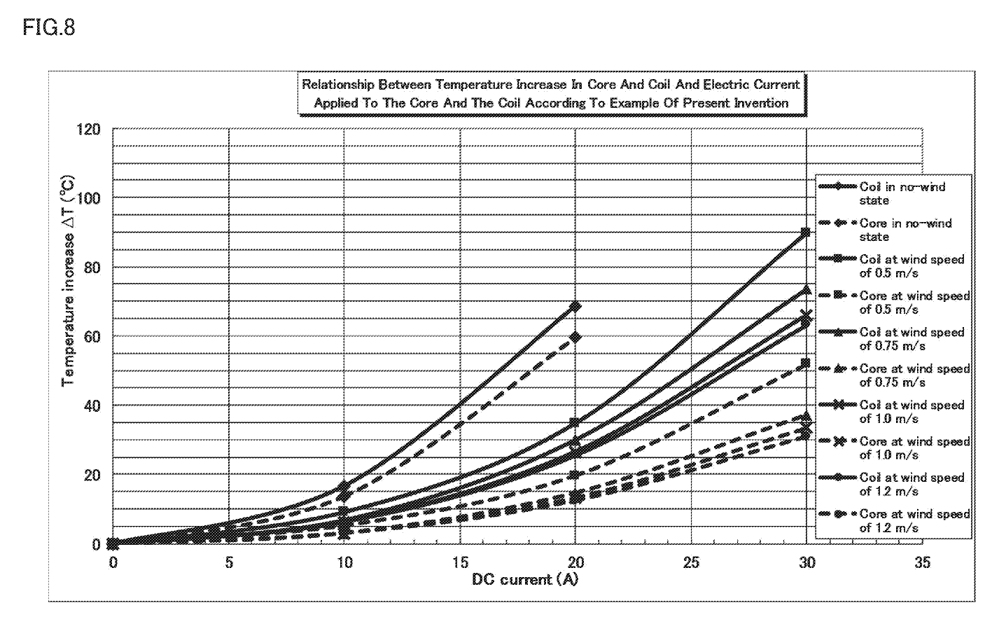

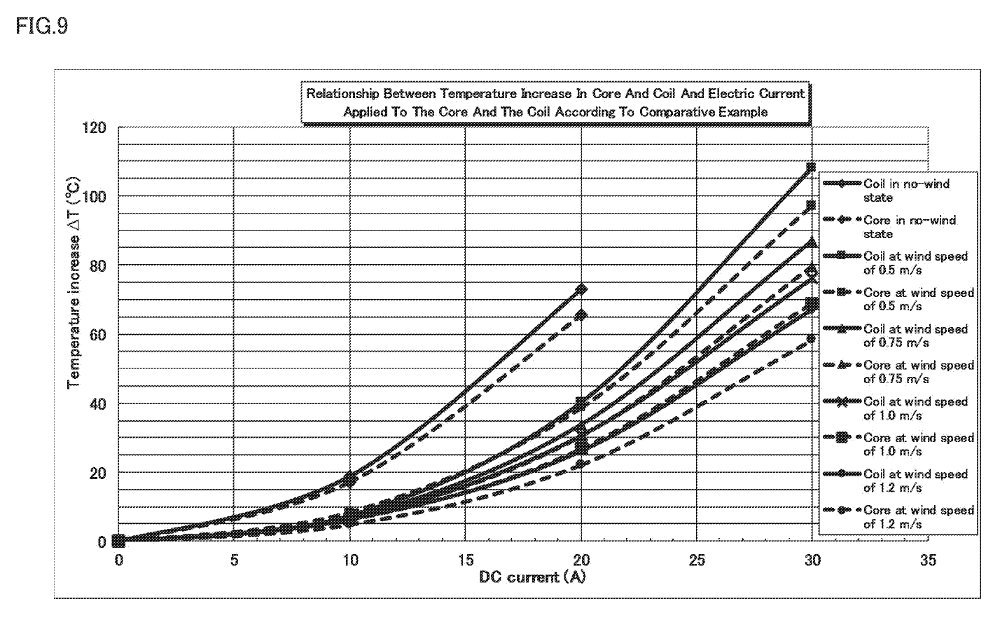

FIG. 8 shows a graph of measurement results of the core 30 and the coils 40 of the example of the present invention shown in Table 1 given above, and FIG. 9 shows a graph of measurement results of the comparative example shown in Table 2 given above.

From FIGS. 8 and 9, it can be seen that, in the example of the present invention, the temperature increase when the same DC current was applied was suppressed as compared with that of the comparative example under all wind speed conditions from the no-wind state to a wind speed of 1.2 m/sec. In particular, when FIGS. 8 and 9 are compared, it can be seen that, in the example of the present invention, the temperature difference between the core 30 and the coils 40 is larger than that of the comparative example under the same measurement conditions, and an increase in the temperature of the core 30 is suppressed.

This is because, as shown in FIG. 6, in the common mode choke coil 10 of the example of the present invention, an airflow B that passes from the opening 21 on the upstream side through the airflow path A and is discharged from the opening 22 on the downstream side is formed, as a result of which the core 30 is cooled, and the bobbin 20 is also cooled from the inside. The air cooling effect is particularly noticeable in the core 30. The temperature of the coils 40 decreased because the coils 40 were cooled as a result of the bobbin 20 being cooled.

On the other hand, in the common mode choke coil of the comparative example, because the openings were closed, the heat generated in the coils was transmitted to the core via the bobbin, and the heat accumulated in the bobbin, as a result of which the temperature of the core increased together with that of the coil.

As described above, in the common mode choke coil 10 of the present invention, as a result of the airflow path A being formed between the core 30 and the openings 21 and 22 in the bobbin 20, an increase in the temperatures of the core 30 and the coils 40 and 40, in particular, an increase in the temperature of the core 30 can be suppressed. Accordingly, even when the core 30 is formed using a magnetic material that has a relatively low Curie temperature, it is possible to apply a large electric current, and enhance the characteristics of the common mode choke coil 10.

The foregoing description is given to merely illustrate the present invention, and thus should not be construed as limiting the present invention recited in the appended claims or narrowing the scope of the present invention. Also, the constituent elements of the present invention are not limited to those in the example described above, and of course, various modifications can be made within the technical scope of the appended claims.

For example, in the embodiment given above, an example is shown in which the casing of the electric appliance includes an air intake opening and an air exhaust fan. However, as can be seen from the results shown in Tables 1 and 2, it is clear that the present invention is effective even in the no-wind state.

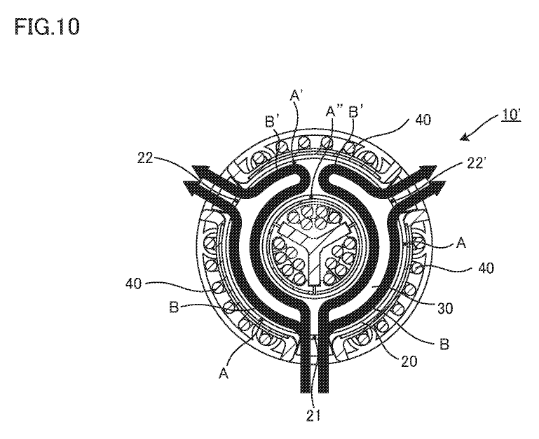

Furthermore, in the foregoing description, a single-phase common mode choke coil 10 is used, but, as shown in FIG. 10, the present invention is also applicable to a three-phase common mode choke coil 10′ in which three coils 40, 40, and 40 are wound around a bobbin 20, or the like. In this case, three openings as indicated by reference numerals 21, 22, and 22′ can be formed between the coils 40, 40, and 40, and, for example, by disposing the common mode choke coil 10′ with the opening 21 pointing toward the upstream side of the airflow, an airflow B that passes from the opening 21 through the airflow path A and is discharged from the openings 22 and 22′ is formed in the bobbin 20, and it is possible to obtain an air cooling effect. At a position between the openings 22 and 22′, an airflow path A has negative pressure due to the airflow that flows out from the openings 22 and 22′, and an airflow B′ that flows from an airflow path A″, which is formed on the circumferential side of the bobbin 20, through the airflow path A and toward the openings 22 and 22′ is formed, and thus the air cooling effect can also be obtained.

### LIST OF REFERENCE NUMERALS

10 Common Mode Choke Coil
20 Bobbin
21 Opening
22 Opening
23 Flange
24 Flange
30 Core
40 Coil
A Airflow Path
B Airflow

1-9. (canceled)

10. A common mode choke coil in which an annular core is housed in an annular bobbin, and a coil is wound around an outer circumference of the bobbin,
wherein an airflow path that allows an airflow to flow therethrough is formed between the bobbin and the core, and
the bobbin has at least one opening that is in communication with the airflow path, and a flange is provided in a protruding manner along a peripheral edge of the opening.

11. The common mode choke coil according to claim 10,
wherein the opening is formed in the outer circumferential surface of the bobbin.

12. The common mode choke coil according to claim 10,
wherein the opening is formed in the outer circumferential surface of the bobbin and reaches upper and lower surfaces of the bobbin.

13. The common mode choke coil according to claim 10,
wherein the flange is flared toward the outer circumference with respect to the opening.

14. The common mode choke coil according to claim 10,
wherein a pair of the openings is provided, and the pair of the openings is formed symmetrically along the diameter of the bobbin.

15. The common mode choke coil according to claim 13,
wherein a pair of the openings is provided, and the pair of the openings is formed symmetrically along the diameter of the bobbin.

16. The common mode choke coil according to claim 10,
wherein the core has a rectangular vertical cross section, and corners of the core abut against and are supported by an inner surface of the bobbin.

17. The common mode choke coil according to claim 13,
wherein the core has a rectangular vertical cross section, and corners of the core abut against and are supported by an inner surface of the bobbin.

18. The common mode choke coil according to claim 14,
wherein the core has a rectangular vertical cross section, and corners of the core abut against and are supported by an inner surface of the bobbin.

19. The common mode choke coil according to claim 10,
wherein a boss or a rib is provided protruding on an inner surface of the bobbin, and
the core abuts against and is supported by the boss or the rib.

20. The common mode choke coil according to claim 13,
wherein a boss or a rib is provided protruding on an inner surface of the bobbin, and
the core abuts against and is supported by the boss or the rib.

21. The common mode choke coil according to claim 14,
wherein a boss or a rib is provided protruding on an inner surface of the bobbin, and
the core abuts against and is supported by the boss or the rib.

22. The common mode choke coil according to claim 10,
wherein the core is a ferrite core.

23. The common mode choke coil according to claim 13,
wherein the core is a ferrite core.

24. The common mode choke coil according to claim 14,
wherein the core is a ferrite core.

25. The common mode choke coil according to claim 19,
wherein the core is a ferrite core.

26. An electric appliance in which the common mode choke coil according to claim 10 is mounted on a board housed in a casing,
wherein the casing includes an air intake opening and an air exhaust fan, and
the common mode choke coil is disposed, with one of the openings pointing toward an upstream side of an airflow formed by the air intake opening and the air exhaust fan.

27. An electric appliance in which the common mode choke coil according to claim 13 is mounted on a board housed in a casing,
wherein the casing includes an air intake opening and an air exhaust fan, and
the common mode choke coil is disposed, with one of the openings pointing toward an upstream side of an airflow formed by the air intake opening and the air exhaust fan.

28. An electric appliance in which the common mode choke coil according to claim 14 is mounted on a board housed in a casing,
wherein the casing includes an air intake opening and an air exhaust fan, and
the common mode choke coil is disposed, with one of the openings pointing toward an upstream side of an airflow formed by the air intake opening and the air exhaust fan.

29. An electric appliance in which the common mode choke coil according to claim 19 is mounted on a board housed in a casing,
wherein the casing includes an air intake opening and an air exhaust fan, and
the common mode choke coil is disposed, with one of the openings pointing toward an upstream side of an airflow formed by the air intake opening and the air exhaust fan.
